(19) United States
(12) Patent Application Publication
(10) Pub. No.: US 2025/0240640 A1
(43) Pub. Date: Jul. 24, 2025

(54) COUNTRY DETERMINATION SERVICE AND UNIFIED REQUEST HANDLER FOR AUTOMATED FREQUENCY COORDINATION (AFC)

(71) Applicant: QUALCOMM Incorporated, San Diego, CA (US)

(72) Inventors: Tevfik YUCEK, San Jose, CA (US); Matthew TORNQUIST, San Francisco, CA (US); Hardik DESAI, San Francisco, CA (US)

(21) Appl. No.: 18/965,919

(22) Filed: Dec. 2, 2024

Related U.S. Application Data
(60) Provisional application No. 63/623,163, filed on Jan. 19, 2024.

(51) Int. Cl. H04W 16/14; H04W 64/00

(52) U.S. Cl. CPC H04W 16/14; H04W 64/003

(57) ABSTRACT

Systems and techniques are provided for providing a country determination service and a unified request handler for AFC. For example, a computing device can receive, from an access point (AP), an application programming interface (API) request associated with an automated frequency coordination (AFC) inquiry, wherein the API request includes location information indicating a location of the AP. The computing device can transmit, to the AP, an API response including at least an indication of a country in which the AP is located and an address associated with an AFC service for the AP.

### CROSS-REFERENCE TO RELATED APPLICATIONS

This application claims the benefit of U.S. Provisional Patent Application No. 63/623,163, filed Jan. 19, 2024, which is hereby incorporated by reference, in its entirety and for all purposes.

### FIELD

The present disclosure generally relates to automated frequency coordination (AFC). For example, aspects of the present disclosure relate to systems and techniques for providing a country determination service and a unified request handler for AFC.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). A wireless multiple-access communications system may include a number of base stations (BSs), access points (APs), or other network entities each simultaneously supporting communications for multiple communication devices, which may be otherwise known as user equipment (UE) or stations (STAs).

For example, a wireless local area network (WLAN) may be formed by one or more access points (APs) that provide a shared wireless communication medium for use by a number of client devices also referred to as stations (STAs). A basic building block of a WLAN conforming to the 802.11 family of standards is a Basic Service Set (BSS), which is managed by an AP. Each BSS is identified by a service set identifier (SSID) that is advertised by the AP. An AP periodically broadcasts beacon frames to enable any STAs within wireless range of the AP to establish and/or maintain a communication link with the WLAN. In a typical WLAN, each STA may be associated with only one AP at a time. To identify an AP with which to associate, a STA is configured to perform scans on the wireless channels of each of one or more frequency bands (for example, the 2.4 GHz band and/or the 5 GHz band). As a result of the increasing ubiquity of wireless networks, a STA may have the opportunity to select one of many WLANs within range of the STA and/or select among multiple APs that together form an extended BSS.

One emerging frequency band of interest for unlicensed wireless communications is the 6 GHz band, which, by some definitions, may extend from about 5925 MHz to about 7250 MHz. However, various incumbent wireless systems already operate in this frequency band. Such existing wireless links include, for example, point-to-point microwave links, big dish antennas, safety systems, TV stations, and satellite earth stations, among other incumbent systems.

### SUMMARY

Systems and techniques are described for providing a country determination service and a unified request handler for AFC.

In some aspects, an apparatus is provided. The apparatus includes at least one memory and at least one processor coupled to the at least one memory and configured to: receive, from an access point (AP), an application programming interface (API) request associated with an automated frequency coordination (AFC) inquiry, wherein the API request includes location information indicating a location of the AP; and transmit, to the AP, an API response including at least an indication of a country in which the AP is located and an address associated with an AFC service for the AP.

In some aspects, a method is provided. The method includes: receiving, from an access point (AP), an application programming interface (API) request associated with an automated frequency coordination (AFC) inquiry, wherein the API request includes location information indicating a location of the AP; and transmitting, to the AP, an API response including at least an indication of a country in which the AP is located and an address associated with an AFC service for the AP.

In some aspects, a non-transitory computer-readable medium is provided having stored thereon instructions that, when executed by at least one processor, cause the at least one processor to: receive, from an access point (AP), an application programming interface (API) request associated with an automated frequency coordination (AFC) inquiry, wherein the API request includes location information indicating a location of the AP; and transmit, to the AP, an API response including at least an indication of a country in which the AP is located and an address associated with an AFC service for the AP.

In some aspects, an apparatus is provided. The apparatus includes: means for receiving, from an access point (AP), an application programming interface (API) request associated with an automated frequency coordination (AFC) inquiry, wherein the API request includes location information indicating a location of the AP; and means for transmitting, to the AP, an API response including at least an indication of a country in which the AP is located and an address associated with an AFC service for the AP.

In some aspects, one or more of the apparatuses described herein is, is part of, and/or includes an extended reality (XR) device or system (e.g., a virtual reality (VR) device, an augmented reality (AR) device, or a mixed reality (MR) device), a mobile device (e.g., a mobile telephone or other mobile device), a wearable device, a wireless communication device, a camera, a personal computer, a laptop computer, a vehicle or a computing device or component of a vehicle, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, the apparatus includes a camera or multiple cameras for capturing one or more images. In some aspects, the apparatus further includes a display for displaying one or more images, notifications, and/or other displayable data. In some aspects, the apparatuses described above can include one or more sensors (e.g., one or more inertial measurement units (IMUs), such as one or more gyroscopes, one or more gyrometers, one or more accelerometers, any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof. So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a block diagram of an example wireless communication system, in accordance with aspects of the present disclosure.

FIG. 2 is a block diagram illustrating a high-level automatic frequency coordination (AFC) functional architecture, in accordance with aspects of the present disclosure.

FIG. 3 is a block diagram of an example user device, in accordance with aspects of the present disclosure.

FIG. 4 is a block diagram of an exemplary access point (AP), in accordance with aspects of the present disclosure.

FIG. 5 is a block diagram of an exemplary AFC unit, in accordance with aspects of the present disclosure.

FIG. 6 is a diagram illustrating an example of a system configured to implement the single uniform resource locator (URL) solution, in accordance with aspects of the present disclosure.

FIG. 7 is a diagram illustrating an example process for determining a country in which an AP is located, in accordance with aspects of the present disclosure.

FIG. 8 is a diagram illustrating an example architecture for a unified request handler and various AFC engines, in accordance with aspects of the present disclosure.

FIG. 9 is a flow diagram illustrating a process for automated frequency coordination, in accordance with aspects of the present disclosure.

FIG. 10 is a flow diagram illustrating a process for automated frequency coordination, in accordance with aspects of the present disclosure.

FIG. 11 is a diagram illustrating an example system architecture for implementing certain aspects described herein.

### DETAILED DESCRIPTION

Certain aspects and examples of this disclosure are provided below. Some of these aspects and examples may be applied independently and some of them may be applied in combination as would be apparent to those of skill in the art. In the following description, for the purposes of explanation, specific details are set forth in order to provide a thorough understanding of aspects and examples of the disclosure. However, it will be apparent that various aspects and examples may be practiced without these specific details. The figures and description are not intended to be restrictive.

The ensuing description provides exemplary aspects and examples only, and is not intended to limit the scope, applicability, or configuration of the disclosure. Rather, the ensuing description of the exemplary aspects and examples will provide those skilled in the art with an enabling description for implementing aspects and examples of the disclosure. It should be understood that various changes may be made in the function and arrangement of elements without departing from the scope of the application as set forth in the appended claims.

As noted previously, wireless communications systems are widely deployed to provide various types of communication content such as voice, video, packet data, messaging, broadcast, and so on. These systems may be capable of supporting communication with multiple users by sharing the available system resources (e.g., time, frequency, and power). For example, a wireless local area network (WLAN) may be formed by one or more access points (APs) that provide a shared wireless communication medium for use by a number of client devices also referred to as stations (STAs).

Various types or classes of APs may be defined, such as Low Power Indoor (LPI), Very Low Power (VLP), and Standard Power (SP) APs. For example, the LPI, VLP, and SP AP classes may be defined for APs configured to operate on the 6 gigahertz (GHz) frequency band (e.g., from 5925 megahertz (MHz) to 7125 MHz). According to the United States Federal Communications Commission (FCC), an LPI AP is defined for fixed indoor use, operates with a 250 milliwatts (mW) Effective Isotropic Radiated Power (EIRP) (which is a measured radiated power of an antenna in a specific direction), has integrated antennas, has no weatherproofing, has wired power, and is labeled for indoor use only. The US FCC also defines an SP AP as an AP defined for fixed indoor and outdoor use, that can operate up to 4 watts (W) EIRP, is coordinated by an AFC database, requires geolocation, and has an elevation angle restriction when operating outdoors. The US FCC defines a VLP AP is defined for mobile indoor and outdoor use, can operate at 25 mW EIRP, and can be used for personal area/in-vehicle use.

To ensure that access points (APs) (e.g., SP AP devices) do not interfere with existing transmitters using a particular frequency (e.g., 6 Gigahertz (GHz), 2.4 GHz, 5 GHZ, etc.), frequency coordination systems, such as AFC systems, provides a way to coordinate the frequency spectrum use. A coordination system, such as an AFC system, requires a new wireless device (e.g., a new SP AP) to consult a registered database to confirm its operation will not impact a registered device (e.g., a registered AP or wireless device, such as a UE, STA, or other wireless device). An AP can include any type of device, such as a Wi-Fi AP, NR-U AP (e.g., base stations, such as gNBs, eNBs, etc.), Bluetooth AP, etc. For example, the term Standard Power AP is a regulatory term that can include any type of device, including Wi-Fi APs, NR-U APs (e.g., base stations, such as gNBs, eNBs, etc.), Bluetooth APs, etc.

A company that provides AFC service may be referred to as an AFC provider. An AFC provider can maintain a database of existing operators on a particular frequency spectrum (e.g., operators of the 6 GHz band). The AFC database can include information associated with the operators, such as geolocation, frequencies, power levels, antenna coverage, any combination thereof, and/or other information associated with the operators on the frequency spectrum. In some cases, the AFC database can be built from an existing database (e.g., the existing FCC database) in which users are required to register their transmitters (e.g., fixed microwave links or radio astronomy receivers).

As noted previously, SP APs may be required to use an AFC service to protect incumbent 6 GHz band operations from radio frequency (RF) interference. For example, an AP (e.g., an SP AP) may communicate with an AFC system, which may automatically determine and provide lists of which frequencies are available for use by the AP operating in, for example, particular bands (e.g., the 6 GHz band).

Multiple countries will develop rules for AFC. Each country may have different rules regarding AFC calculations, AFC interfaces, hosting requirements (e.g., some countries are expected to require AFCs to be hosted in their own territory), and/or other items. In some cases, manufactures may want to build a single AP implementing AFC that may be used in multiple countries. Thus, systems and techniques for providing a country determination service and a unified request handler for AFC may be useful.

A single SP AP device (e.g., AP device or AP) can be certified for Standard Power (with AFC) operation in multiple countries. In such cases, the AP may discover a correct AFC system based on a location of the AP (e.g., a particular regulatory region corresponding to a location of an AP). In some cases, the AP may obtain contact information for the AFC system based on the location of the AP, and may use the obtained contact information to contact the correct AFC system for access. One solution may be to hardcode the location for each AP. However, hardcoding the location for each AP requires multiple device identifiers (e.g., stock keeping units (SKUs) to be setup and the software in each AP to be controlled separately, causing large logistics overhead.

Various implementations described herein relate generally to systems and techniques for providing a country determination service and a unified request handler for AFC. In some aspects, the systems and techniques provide a single end point (e.g., a unified request handler) and/or address (e.g., uniform resource locator (URL)) that can be accessed for AFC operation. Using the single end point and/or address can allow a unified request handler to correctly route an AFC inquiry from an AP (e.g., an SP AP) to a correct AFC system based on a location of an AP (e.g., to an AFC system of a specific country that corresponds to the location of the AP) which is included in the AFC inquiry from the AP. In some cases, the unified request handler can respond to the AP with information that the AP can use to send a request to a correct AFC system. In some implementations, the unified request handler can be an AFC system frontend of an AFC system.

For example, according to some aspects, as an AP provides its location to the unified request handler, the unified request handler can direct the inquiry to a correct AFC service (e.g., for a particular country) based on the unified request handler verifying that the AP is certified for that region and determining the country of operation for the AP. In some cases, in order to not run the country determination logic for each inquiry, a cache table (or database or other storage) can be built in the AFC system.

Two illustrative approaches are described herein, including a dedicated country determination application programming interface (API) and an integrated single URL solution. In some cases, the API and integrated single URL systems may both be jointly hosted or hosted separately.

The systems and techniques described herein can be used for any type of AP, including Wi-Fi APs, NR-U APs (e.g., base stations, such as gNBs, eNBs, etc.), Bluetooth APs, etc.

Various aspects of the present disclosure will be described with respect to the figures. The aspects described herein can be implemented in any device, system or network that is capable of transmitting and receiving radio frequency (RF) signals according to any of the IEEE 802.11 standards, or the Bluetooth® standards. The described implementations also can be implemented in any device, system or network that is capable of transmitting and receiving RF signals according to any of the following technologies or techniques: code division multiple access (CDMA), frequency division multiple access (FDMA), orthogonal frequency division multiple access (OFDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless, cellular or internet of things (IoT) network, such as a system utilizing 3G, 4G or 5G, or further implementations thereof, technology.

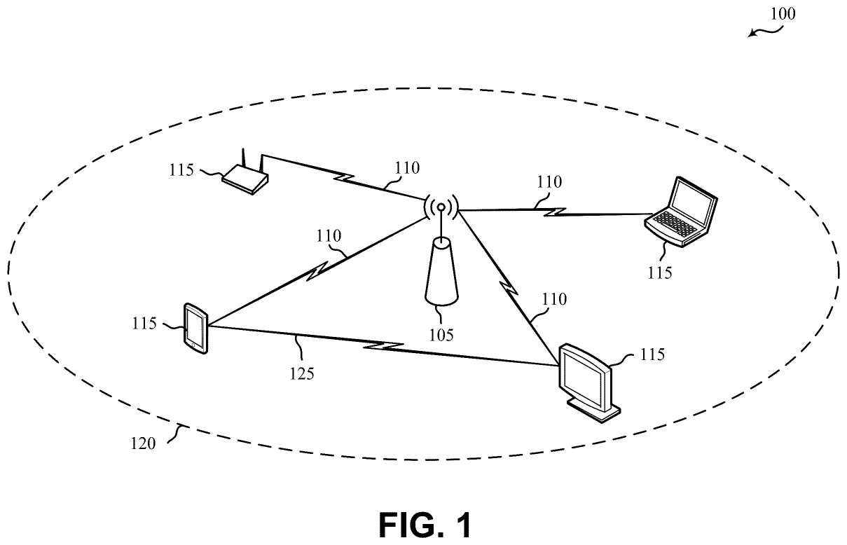

FIG. 1 shows a block diagram of an example wireless communication system 100. According to some aspects, the wireless communication system 100 can be an example of a wireless local area network (WLAN) (and will hereinafter be referred to as WLAN 100). For example, the WLAN 100 can be a network implementing at least one of the IEEE 802.11 family of standards. The WLAN 100 may include numerous wireless communication devices such as an access point (AP) 105 and multiple associated stations (STAs) 115. Each of the STAs 115 also may be referred to as a mobile station (MS), a mobile device, a mobile handset, a wireless handset, an access terminal (AT), a user equipment (UE), a subscriber station (SS), or a subscriber unit, among other possibilities. The STAs 115 may represent various devices such as mobile phones, personal digital assistant (PDAs), other handheld devices, netbooks, notebook computers, tablet computers, laptops, display devices (for example, TVs, computer monitors, navigation systems, among others), printers, key fobs (for example, for passive keyless entry and start (PKES) systems), among other possibilities.

Each of the STAs 115 may associate and communicate with the AP 105 via a communication link 110. The various STAs 115 in the network are able to communicate with one another through the AP 105. A single AP 105 and an associated set of STAs 115 may be referred to as a basic service set (BSS). FIG. 1 additionally shows an example coverage area 120 of the AP 105, which may represent a basic service area (BSA) of the WLAN 100. While only one AP 105 is shown, the WLAN network 100 can include multiple APs 105. An extended service set (ESS) may include a set of connected BSSs. An extended network station associated with the WLAN 100 may be connected to a wired or wireless distribution system that may allow multiple APs 105 to be connected in such an ESS. As such, a STA 115 can be covered by more than one AP 105 and can associate with different APs 105 at different times for different transmissions.

STAs 115 may function and communicate (via the respective communication links 110) according to the IEEE 802.11 family of standards and amendments including, but not limited to, 802.11a, 802.11b, 802.11 g, 802.11n, 802.11ac, 802.11ad, 802.11ah, 802.11ay, 802.11ax, 802.11az, and 802.11ba. These standards define the WLAN radio and baseband protocols for the PHY and medium access control (MAC) layers. The wireless devices in the WLAN 100 may communicate over an unlicensed spectrum, which may be a portion of spectrum that includes frequency bands traditionally used by Wi-Fi technology, such as the 2.4 GHz band, the 5 GHz band, the 60 GHz band, the 3.6 GHz band, and the 900 MHz band. Some implementations of the wireless devices described herein also may communicate in other frequency bands, such as the emerging 6 GHz band, which may support both licensed and unlicensed communications. The wireless devices in the WLAN 100 also can be configured to communicate over other frequency bands such as shared licensed frequency bands, where multiple operators may have a license to operate in the same or overlapping frequency band or bands.

In some cases, STAs 115 may form networks without APs 105 or other equipment other than the STAs 115 themselves. One example of such a network is an ad hoc network (or wireless ad hoc network). Ad hoc networks may alternatively be referred to as mesh networks or peer-to-peer (P2P) connections. In some cases, ad hoc networks may be implemented within a larger wireless network such as the WLAN 100. In such implementations, while the STAs 115 may be capable of communicating with each other through the AP 105 using communication links 110, STAs 115 also can communicate directly with each other via direct wireless communication links 125. Additionally, two STAs 115 may communicate via a direct communication link 125 regardless of whether both STAs 115 are associated with and served by the same AP 105. In such an ad hoc system, one or more of the STAs 115 may assume the role filled by the AP 105 in a BSS. Such a STA 115 may be referred to as a group owner (GO) and may coordinate transmissions within the ad hoc network. Examples of direct wireless communication links 125 include Wi-Fi Direct connections, connections established by using a Wi-Fi Tunneled Direct Link Setup (TDLS) link, and other peer-to-peer (P2P) group connections.

Some types of STAs 115 may provide for automated communication. Automated wireless devices may include those implementing internet-of-things (IoT) communication, Machine-to-Machine (M2M) communication, or machine type communication (MTC). IoT, M2M or MTC may refer to data communication technologies that allow devices to communicate without human intervention. For example, IoT, M2M or MTC may refer to communications from STAs 115 that integrate sensors or meters to measure or capture information and relay that information to a central server or application program that can make use of the information or present the information to humans interacting with the program or application.

Some of STAs 115 may be MTC devices, such as MTC devices designed to collect information or enable automated behavior of machines. Examples of applications for MTC devices include smart metering, inventory monitoring, water level monitoring, equipment monitoring, healthcare monitoring, wildlife monitoring, weather and geological event monitoring, fleet management and tracking, remote security sensing, physical access control, and transaction-based business charging. An MTC device may operate using half-duplex (one-way) communications at a reduced peak rate. MTC devices may also be configured to enter a power saving “deep sleep” mode when not engaging in active communications.

WLAN 100 may support beamformed transmissions. As an example, AP 105 may use multiple antennas or antenna arrays to conduct beamforming operations for directional communications with a STA 115. Beamforming (which may also be referred to as spatial filtering or directional transmission) is a signal processing technique that may be used at a transmitter (e.g., AP 105) to shape and/or steer an overall antenna beam in the direction of a target receiver (e.g., a STA 115). Beamforming may be achieved by combining elements in an antenna array in such a way that transmitted signals at particular angles experience constructive interference while others experience destructive interference. In some cases, the ways in which the elements of the antenna array are combined at the transmitter may depend on channel state information (CSI) associated with the channels over which the AP 105 may communicate with the STA 115. That is, based on this CSI, the AP 105 may appropriately weight the transmissions from each antenna (e.g., or antenna port) such that the desired beamforming effects are achieved. In some cases, these weights may be determined before beamforming can be employed. For example, the transmitter (e.g., the AP 105) may transmit one or more sounding packets to the receiver in order to determine CSI.

WLAN 100 may further support multiple-input, multiple-output (MIMO) wireless systems. Such systems may use a transmission scheme between a transmitter (e.g., AP 105) and a receiver (e.g., a STA 115), where both transmitter and receiver are equipped with multiple antennas. For example, AP 105 may have an antenna array with a number of rows and columns of antenna ports that the AP 105 may use for beamforming in its communication with a STA 115. Signals may be transmitted multiple times in different directions (e.g., each transmission may be beamformed differently). The receiver (e.g., STA 115) may try multiple beams (e.g., antenna subarrays) while receiving the signals.

WLAN PDUs may be transmitted over a radio frequency spectrum band, which in some examples may include multiple sub-bands or frequency channels. In some cases, the radio frequency spectrum band may have a bandwidth of 80 MHz, and each of the sub-bands or channels may have a bandwidth of 20 MHz. Transmissions to and from STAs 115 and APs 105 typically include control information within a header that is transmitted prior to data transmissions. The information provided in a header is used by a receiving device to decode the subsequent data. A legacy WLAN preamble may include legacy short training field (STF) (L-STF) information, legacy LTF (L-LTF) information, and legacy signaling (L-SIG) information. The legacy preamble may be used for packet detection, automatic gain control and channel estimation, among other uses. The legacy preamble may also be used to maintain compatibility with legacy devices.

In some cases, the wireless communication system 100 may operate over a shared channel, which may include shared frequency bands or unlicensed frequency bands. In other cases, the wireless communication system 100 may operate over a 6 GHz frequency band, which may include licensed incumbents. The licensed incumbents may operate as primary users and the AP 105 may communicate with the STAs 115 operating as secondary users for sharing the frequency band. In some aspects, the sharing of the frequency band may be controlled by an automated frequency coordination (AFC) system or entity. The AFC entity may maintain a list of available frequencies and/or frequency bands that are not occupied by a licensed incumbent at each geographical location. An AP 105 desiring to access the frequency band may determine a geographical location of AP 105 and consult with the AFC system regarding available frequencies and/or frequency bands in the area of operation. The AP 105 may select a frequency band for communications with a STA 115 based on the consultation with the AFC system. As described in more detail here, various implementations described herein relate generally to systems and techniques for providing a country determination service and a unified request handler for AFC.

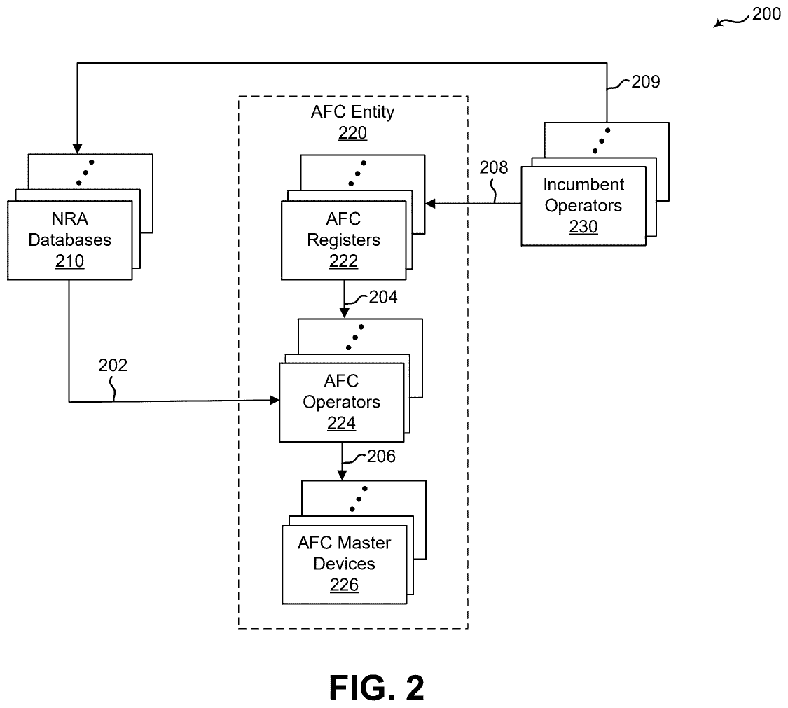

FIG. 2 illustrates a high-level AFC architecture 200 according to some aspects of the present disclosure. The AFC architecture 200 may be employed by the network 100 for sharing a frequency band, for example, a 6 GHz band. The AFC architecture 200 includes a plurality of national regulatory authority (NRA) databases 210, an AFC entity 220, and a plurality of incumbent operators 230. The incumbent operators 230 are licensed holders with one or more protected receivers (e.g., FS receivers and/or FSS receivers) in a regulatory domain.

The NRA databases 210 are electronic databases controlled and maintained by national regulators. Examples of national regulators may include United States (US) FCC, United Kingdom (UK) office of communications (Ofcom), and France agency national frequency (ANFR). The NRA databases 210 may include licensing data associated with the incumbent operators 230. The NRA databases 210 may include parameters associated with protected services of the incumbent operators 230. The parameters may include frequencies used by the incumbent operators 230 and/or geographical locations of the incumbent operators 230. The incumbent operators 230 may register with the NRA databases 210 according to NRA licensing procedures as shown by the arrow 209.

The AFC entity 220 includes one or more AFC registrars 222, one or more AFC operators 224, and one or more AFC master devices 226. In some cases, the AFC entity 220 does not include an AFC registrars 222. The AFC operators 224 include software, servers, network units, and/or network systems configured to perform AFC functions that are in compliance with an AFC regulatory body (e.g., including the FCC or other governmental organization, Wi-Fi Alliance (WFA), 3GPP) and certified by NRA. The AFC operators 224 may include radio local area network (RLAN) equipment manufacturers, mobile device manufacturers, and/or spectrum database operators.

The AFC registrars 222 include electronic databases of the approved and certified AFC operators 224. The AFC registrars 222 may include AFC identifiers and/or point of contact information associated with the AFC operators 224. The AFC registrars 222 may maintain and track interference reports received from the incumbent operators 230 (e.g., via web forms) as shown by the arrows 208. In some examples, the AFC entity may include contour modification databases that maintain and track protection contours associated with each individual site of the incumbent operators 230. The AFC registrars 222 may perform temporary and/or permanent protection contour modifications for the individual incumbent sites and/or synchronize AFC identifiers and/or modifications with the contour modification databases. The AFC registrars 222 may maintain and track frequency bands that are available for use by unlicensed devices. In some examples, there may be about 2-3 AFC registrars 222 worldwide.

The AFC master devices 226 include access points (APs) and/or base stations, such as the AP 105 of FIG. 1. In some cases, the APs are Standard Power (SP) APs. The AFC master devices 226 may implement a certain protocol for communicating with a server of an AFC operator 224. The AFC master devices 226 may establish a wireless network connection to serve a client device, such as stations (STAs) (e.g., STAs 115 of FIG. 1) or UEs (e.g., of a 3rd Generation Partnership Project (3GPP) wireless communication system). Each AFC master device 226 may have knowledge of its own geographical location information.

The AFC operators 224 may be in communication with the AFC registrars 222, the NRA databases 210, and the AFC master devices 226. In an example, the AFC operators 224 may query one or more of the NRA databases 210 to obtain licensing information, geographical location information, and/or frequency information associated with the incumbent operators 230 via an AFC-NRA protocol as shown by the arrow 202. In an example, the AFC operators 224 may query one or more of the AFC registrars 222 for AFC information, such as available frequency bands, via an AFC-registrar protocol as shown by the arrow 204. In an example, AFC operators 224 may communicate with the AFC master devices 226 via an AFC-master protocol as shown by the arrow 206. An AFC master device 226 may request spectrum access from an AFC operator 224. The AFC master device 226 may indicate to the AFC operator 224 a geographical location of the AFC master device 226. The AFC operator 224 may grant spectrum access to a requesting AFC master device 226 based on the geographical location of the AFC master device 226 and/or AFC information retrieved from one or more of the AFC registrars 222. The AFC operators 224 may indicate to the requesting AFC master device 226 which part of the frequency band is free to use.

According to aspects of the present disclosure, in addition to protecting incumbent services, the AFC operators 224 may query one or more of the AFC registrars 222 regarding medium access information and/or supported protocol and/or RAT information for use among various network operating entities (e.g., 3GPP operators and/or WFA operators) in accessing the frequency band. Thus, the AFC operators can be utilized to control medium access procedures and/or communication protocol versions that are allowed in certain standards and/or load balancing and/or coexistence among different technologies. AFC operators and/or AFC registrars are to be accredited by certain wireless communication industry standards (e.g., 3GPP and WFA). AFC operators among different standards and/or technologies may coordinate and agree with each other in determining medium access parameters, protocol version parameters, and/or RAT parameters in sharing a spectrum.

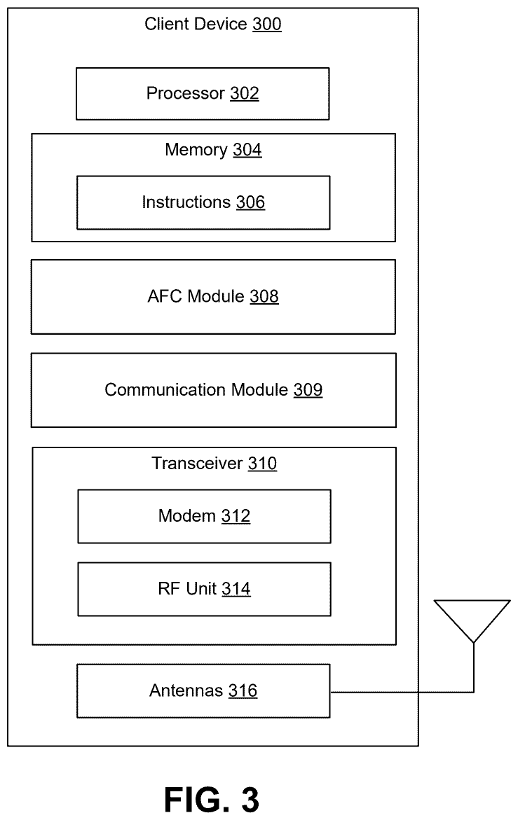

FIG. 3 is a block diagram of an exemplary client device 300 according to aspects of the present disclosure. The client device 300 may be a STA 115 in the network 100 as discussed above in FIG. 1 or may be a UE (utilizing a 3GPP communication system). As shown, the client device 300 may include a processor 302, a memory 304, an AFC module 308, a communication module 309, a transceiver 310 including a modem subsystem 312 and a radio frequency (RF) unit 314, and one or more antennas 316. These elements may be in direct or indirect communication with each other, for example via one or more buses.

The processor 302 may include a central processing unit (CPU), a digital signal processor (DSP), an application specific integrated circuit (ASIC), a controller, a field programmable gate array (FPGA) device, another hardware device, a firmware device, or any combination thereof configured to perform the operations described herein. The processor 302 may also be implemented as a combination of computing devices, e.g., a combination of a DSP and a microprocessor, a plurality of microprocessors, one or more microprocessors in conjunction with a DSP core, or any other such configuration.

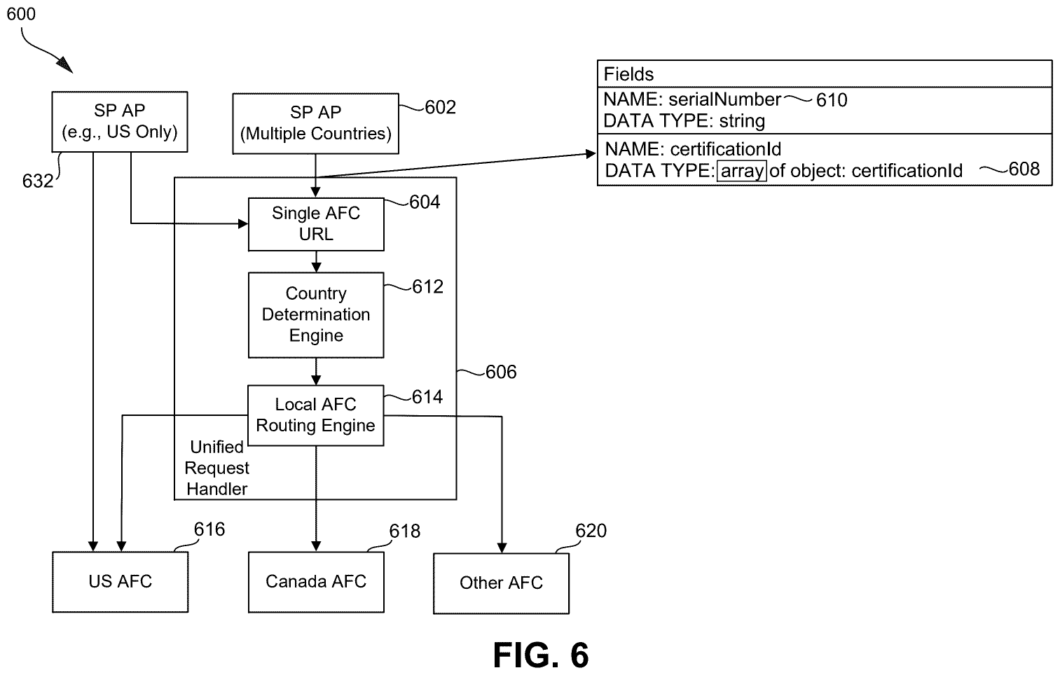

The memory 304 may include a cache memory (e.g., a cache memory of the processor 302), random access memory (RAM), magnetoresistive RAM (MRAM), read-only memory (ROM), programmable read-only memory (PROM), erasable programmable read only memory (EPROM), electrically erasable programmable read only memory (EEPROM), flash memory, solid state memory device, hard disk drives, other forms of volatile and non-volatile memory, or a combination of different types of memory. In an aspect, the memory 304 includes a non-transitory computer-readable medium. The memory 304 may store instructions 306. The instructions 306 may include instructions that, when executed by the processor 302, cause the processor 302 to perform the operations described herein with reference to the client devices 115 in connection with aspects of the present disclosure, for example, aspects of FIGS. 6-8. Instructions 306 may also be referred to as code. The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

Each of the AFC module 308 and the communication module 309 may be implemented via hardware, software, or combinations thereof. For example, each of the AFC module 308 and the communication module 309 may be implemented as a processor, circuit, and/or instructions 306 stored in the memory 304 and executed by the processor 302. In some examples, the AFC module 308 and/or the communication module 309 can be integrated within the modem subsystem 312. For example, the AFC module 308 and/or the communication module 309 can be implemented by a combination of software components (e.g., executed by a DSP or a general processor) and hardware components (e.g., logic gates and circuitry) within the modem subsystem 312. In some examples, a client device (e.g., a STA, UE, etc.) may include the AFC module 308 or the communication module 309. In other examples, a client device (e.g., a STA, UE, etc.) may include AFC module 308 and the communication module 309.

The AFC module 308 and the communication module 309 may be used for various aspects of the present disclosure, for example, aspects of FIGS. 1-2 and 6-7. For example, the AFC module 308 is configured to request access to a spectrum from an AFC operator (e.g., the AFC operators 224) and receive a spectrum access grant from the AFC operator. The spectrum access grant may include medium access procedure or protocol information, such as a reservation signal waveform type, a reservation detection mode (e.g., energy detection or signal detection), a medium contention mode (e.g., synchronous or asynchronous), and/or an LBT mode (e.g., CAT2 LBT and/or CAT4 LBT). The spectrum access grant may indicate a version of a communication standard, specification, or protocol that is allowed to access a particular subband of the spectrum. The spectrum access grant may indicate a technology (e.g., 3GPP or WiFi) that is allowed to access a particular subband of the spectrum. The AFC module 308 is configured to perform medium access or LBT based on the configuration provided by the spectrum access grant. In some examples, the spectrum access request may include geographical location information of the client device 300 and the spectrum access grant may include medium access, protocol versioning, and/or RAT configuration information for the particular location of the client device 300. Mechanisms for performing AFC are described in greater detail herein.

The communication module 309 is configured to perform frequency scan over a list of available frequencies, for example, obtained from an AFC operator via the AFC module 308. The communication module 309 is configured to initiate communications with an AP (e.g., the APs 105) in the spectrum by upon a successful LBT. The communication module 309 is configured to receive scheduling grants from the AP and communicate UL data, UL control information, DL data, and/or DL control information with the AP based on the scheduling grants.

In some other aspects, the client device 300 may not include the AFC module 308 and may not communicate with an AFC operator directly. Instead, the client device 300 may rely on a serving AP to obtain a spectrum access grant from an AFC operator and communicate with the serving AP based on schedules granted by the AP.

As shown, the transceiver 310 may include the modem subsystem 312 and the RF unit 314. The transceiver 310 can be configured to communicate bi-directionally with other devices, such as the APs 105. The modem subsystem 312 may be configured to modulate and/or encode the data from the memory 304, the AFC module 308, and/or the communication module 309 according to a modulation and coding scheme (MCS), e.g., a low-density parity check (LDPC) coding scheme, a turbo coding scheme, a convolutional coding scheme, a digital beamforming scheme, etc. The RF unit 314 may be configured to process (e.g., perform analog to digital conversion or digital to analog conversion, etc.) modulated/encoded data from the modem subsystem 312 (on outbound transmissions) or of transmissions originating from another source such as a STA 115 or an AP 105. The RF unit 314 may be further configured to perform analog beamforming in conjunction with the digital beamforming. Although shown as integrated together in transceiver 310, the modem subsystem 312 and the RF unit 314 may be separate devices that are coupled together at the client device 300 to enable the client device 300 to communicate with other devices.

The RF unit 314 may provide the modulated and/or processed data, e.g. data packets (or, more generally, data messages that may contain one or more data packets and other information), to the antennas 316 for transmission to one or more other devices. The antennas 316 may further receive data messages transmitted from other devices. The antennas 316 may provide the received data messages for processing and/or demodulation at the transceiver 310. The antennas 316 may include multiple antennas of similar or different designs in order to sustain multiple transmission links. The RF unit 314 may configure the antennas 316.

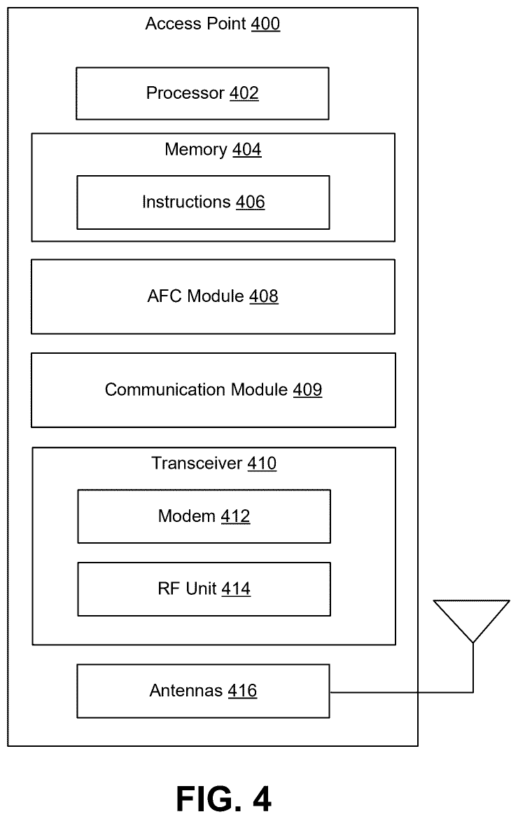

FIG. 4 is a block diagram of an exemplary AP 400 according to aspects of the present disclosure. The AP 400 may be an AP 105 in the network 100 as discussed above in FIG. 1. As shown, the AP 400 may include a processor 402, a memory 404, an AFC module 408, a communication module 409, a transceiver 410 including a modem subsystem 412 and a RF unit 414, and one or more antennas 416. These elements may be in direct or indirect communication with each other, for example via one or more buses.

The processor 402 may have various features as a specific-type processor. For example, these may include a CPU, a DSP, an ASIC, a controller, a FPGA device, another hardware device, a firmware device, or any combination thereof configured to perform the operations described herein. The processor 402 may also be implemented as a combination of computing devices, e.g., a combination of a DSP and a microprocessor, a plurality of microprocessors, one or more microprocessors in conjunction with a DSP core, or any other such configuration.

The memory 404 may include a cache memory (e.g., a cache memory of the processor 402), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 404 may include a non-transitory computer-readable medium. The memory 404 may store instructions 406. The instructions 406 may include instructions that, when executed by the processor 402, cause the processor 402 to perform operations described herein, for example, aspects of FIGS. 1-2 and 6-8. Instructions 406 may also be referred to as code, which may be interpreted broadly to include any type of computer-readable statement(s) as discussed above with respect to FIG. 3.

Each of the AFC module 408 and the communication module 409 may be implemented via hardware, software, or combinations thereof. For example, each of the AFC module 408 and the communication module 409 may be implemented as a processor, circuit, and/or instructions 406 stored in the memory 404 and executed by the processor 402. In some examples, the AFC module 408 and/or the communication module 409 can be integrated within the modem subsystem 412. For example, the AFC module 408 and/or the communication module 409 can be implemented by a combination of software components (e.g., executed by a DSP or a general processor) and hardware components (e.g., logic gates and circuitry) within the modem subsystem 412. In some examples, a AP may include the AFC module 408 or the communication module 409. In other examples, a AP may include the AFC module 408 and the communication module 409.

The AFC module 408 and the communication module 409 may be used for various aspects of the present disclosure, for example, aspects of FIGS. 1-2 and 6-8. For example, the AFC module 408 is configured to request access to a spectrum from an AFC operator (e.g., the AFC operators 224) and receive a spectrum access grant from the AFC operator. The spectrum access grant may include medium access procedure or protocol information, such as a reservation signal waveform type, a reservation detection mode (e.g., energy detection or signal detection), a medium contention mode (e.g., synchronous or asynchronous), and/or an LBT mode (e.g., CAT2 LBT and/or CAT4 LBT). The spectrum access grant may indicate a version of a communication standard, specification, or protocol that is allowed to access a particular subband of the spectrum. The spectrum access grant may indicate a technology (e.g., 3GPP or WiFi) that is allowed to access a particular subband of the spectrum. The AFC module 408 is configured to perform medium access or LBT based on the configuration provided by the spectrum access grant. In some examples, the spectrum access request may include geographical location information of the AP 400 and the spectrum access grant may include medium access, protocol versioning, and/or RAT configuration information for the particular location of the AP 400. Mechanisms for performing AFC are described in greater detail herein.

The communication module 409 is configured to schedule UL and/or DL communications with a client device (e.g., the STAs 115, the client device 300, etc.) upon a successfully LBT, transmit UL and/or DL scheduling grants to the client device, and/or communicate with the client device according to the scheduling grants.

As shown, the transceiver 410 may include the modem subsystem 412 and the RF unit 414. The transceiver 410 can be configured to communicate bi-directionally with other devices, such as the STAs 115 and/or another core network element. The modem subsystem 412 may be configured to modulate and/or encode data according to a MCS, e.g., a LDPC coding scheme, a turbo coding scheme, a convolutional coding scheme, a digital beamforming scheme, etc. The RF unit 414 may be configured to process (e.g., perform analog to digital conversion or digital to analog conversion, etc.) modulated/encoded data from the modem subsystem 412 (on outbound transmissions) or of transmissions originating from another source such as a client device (e.g., the STAs 115 and/or client device 300). The RF unit 414 may be further configured to perform analog beamforming in conjunction with the digital beamforming. Although shown as integrated together in transceiver 410, the modem subsystem 412 and/or the RF unit 414 may be separate devices that are coupled together at the AP 105 to enable the AP 105 to communicate with other devices.

The RF unit 414 may provide the modulated and/or processed data, e.g. data packets (or, more generally, data messages that may contain one or more data packets and other information), to the antennas 416 for transmission to one or more other devices. The antennas 416 may further receive data messages transmitted from other devices and provide the received data messages for processing and/or demodulation at the transceiver 410. The antennas 416 may include multiple antennas of similar or different designs in order to sustain multiple transmission links.

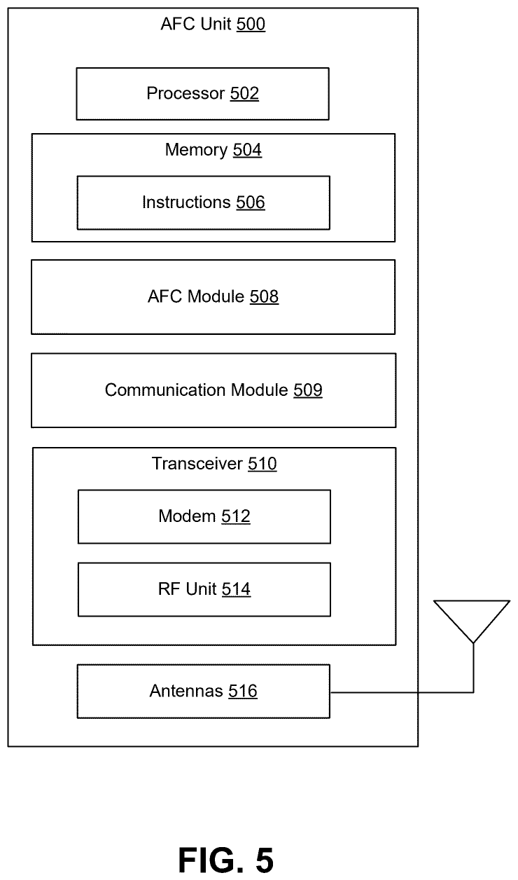

FIG. 5 is a block diagram of an exemplary AFC unit according to aspects of the present disclosure. The AFC unit 500 may be an AFC operator 224 or an AFC registrar 222 in the AFC architecture 200 as discussed above in FIG. 2. As shown, the AFC unit 500 may include a processor 502, a memory 504, an AFC module 508, a communication module 509, a transceiver 510 including a modem subsystem 512 and a RF unit 514, and one or more antennas 516. These elements may be in direct or indirect communication with each other, for example via one or more buses.

The processor 502 may have various features as a specific-type processor. For example, these may include a CPU, a DSP, an ASIC, a controller, a FPGA device, another hardware device, a firmware device, or any combination thereof configured to perform the operations described herein. The processor 502 may also be implemented as a combination of computing devices, e.g., a combination of a DSP and a microprocessor, a plurality of microprocessors, one or more microprocessors in conjunction with a DSP core, or any other such configuration.

The memory 504 may include a cache memory (e.g., a cache memory of the processor 502), RAM, MRAM, ROM, PROM, EPROM, EEPROM, flash memory, a solid state memory device, one or more hard disk drives, memristor-based arrays, other forms of volatile and non-volatile memory, or a combination of different types of memory. In some aspects, the memory 504 may include a non-transitory computer-readable medium. The memory 504 may store instructions 506. The instructions 506 may include instructions that, when executed by the processor 502, cause the processor 502 to perform operations described herein, for example, aspects of FIGS. 1-2, 6, and 8. Instructions 506 may also be referred to as code, which may be interpreted broadly to include any type of computer-readable statement(s) as discussed above with respect to FIG. 3.

Each of the AFC module 508 and the communication module 509 may be implemented via hardware, software, or combinations thereof. For example, each of the AFC module 508 and the communication module 509 may be implemented as a processor, circuit, and/or instructions 506 stored in the memory 504 and executed by the processor 502. In some examples, the AFC module 508 and/or the communication module 509 can be integrated within the modem subsystem 512. For example, the AFC module 508 and/or the communication module 509 can be implemented by a combination of software components (e.g., executed by a DSP or a general processor) and hardware components (e.g., logic gates and circuitry) within the modem subsystem 512.

The AFC module 508 and the communication module 509 may be used for various aspects of the present disclosure, for example, aspects of FIGS. 1-2, 6, and 8. For example, the AFC module 508 is configured to receive a request from an AFC master device (e.g., the APs 105 and the AFC master devices 226) and/or a client device (e.g., the STAs 115 and/or the client device 300) requesting to access a spectrum, query one or more AFC registrars (e.g., the AFC registrars 222) for configuration information related to accessing the spectrum, and transmit a spectrum access grant to the requesting device based on the configuration information. The spectrum access grant may include medium access procedure or protocol information, such as a reservation signal waveform, reservation detection mode (e.g., energy detection or signal detection), a medium contention mode (e.g., synchronous or asynchronous). The spectrum access grant may indicate a version of a communication standard or protocol that is allowed to access a particular subband of the spectrum. The spectrum access grant may indicate a technology (e.g., 3GPP and/or WiFi) that is allowed to access a particular subband of the spectrum. In some examples, the spectrum access request may include geographical location information of the requesting device and the spectrum access grant may include medium access, protocol versioning, and/or RAT configuration information for the particular location of the requesting device.

In some aspects, the AFC unit 500 corresponds to an AFC operator (e.g., the AFC operators 224). In such aspects, the AFC module 508 is configured to transmit access configuration queries to one or more AFC registrars (e.g., the AFC registrars 222) and receive configuration information from the AFC registrars. In some aspects, the AFC unit 500 corresponds to an AFC registrar. In such aspects, the AFC module 508 is configured to receive access configuration queries from an AFC operator and respond to the queries by transmitting configuration information to the AFC registrars. In some examples, when the AFC unit 500 is associated with 3GPP, the AFC module 508 is configured to query 3GPP AFC registrars and/or WFA registrars. In some examples, when the AFC unit 500 is associated with WFA, the AFC module 508 is configured to query 3GPP AFC registrars and/or WFA registrars. Mechanisms for performing AFC are described in greater detail herein.

The communication module 509 is configured to communicate with AFC registrars, NRA registrars, AFC operators, AFC master devices and/or client devices.

As shown, the transceiver 510 may include the modem subsystem 512 and the RF unit 514. The transceiver 510 can be configured to communicate bi-directionally with other devices, such as the STAs 115 and/or another core network element. The modem subsystem 512 may be configured to modulate and/or encode data according to a MCS, e.g., a LDPC coding scheme, a turbo coding scheme, a convolutional coding scheme, a digital beamforming scheme, etc. The RF unit 514 may be configured to process (e.g., perform analog to digital conversion or digital to analog conversion, etc.) modulated/encoded data from the modem subsystem 512 (on outbound transmissions) or of transmissions originating from another source such as a client device (e.g., the STAs 115 and/or client device 300). The RF unit 514 may be further configured to perform analog beamforming in conjunction with the digital beamforming. Although shown as integrated together in transceiver 510, the modem subsystem 512 and/or the RF unit 514 may be separate devices that are coupled together at the AP 105 to enable the AP 105 to communicate with other devices.

The RF unit 514 may provide the modulated and/or processed data, e.g. data packets (or, more generally, data messages that may contain one or more data packets and other information), to the antennas 516 for transmission to one or more other devices. The antennas 516 may further receive data messages transmitted from other devices and provide the received data messages for processing and/or demodulation at the transceiver 510. The antennas 516 may include multiple antennas of similar or different designs in order to sustain multiple transmission links.

As noted previously, multiple countries will develop rules for AFC, and each country may have different rules regarding AFC calculations, AFC interfaces, hosting requirements (e.g., some countries are expected to require AFCs to be hosted in their own territory), and/or other items. A single SP AP device can be certified for Standard Power (with AFC) operation in multiple countries. As previously described, hardcoding the location for each AP requires multiple device identifiers (e.g., stock keeping units (SKUs)) to be setup and the software in each AP to be controlled separately, causing a large logistics overhead. In some cases, the AP may instead be able to inquire about a correct AFC system for a location of the AP (e.g., a particular regulatory region corresponding to a location of an AP), obtain contact information for the AFC system based on the AP's location, and contact the correct AFC system for access.

Aspects described herein relate generally to systems and techniques for providing a country determination service and a unified request handler for AFC. For example, the systems and techniques can provide a single end point (e.g., a unified request handler) and/or address (e.g., uniform resource locator (URL)) that can be accessed for AFC operation. Using the single end point and/or address can allow a unified request handler to correctly route an AFC inquiry from an AP (e.g., an SP AP) to a correct AFC system based on a location of an AP (e.g., to an AFC system of a specific country that corresponds to the location of the AP) which is included in the AFC inquiry from the AP. In some cases, the unified request handler can respond to the AP with information that the AP can use to send a request to a correct AFC system. In some implementations, the unified request handler can be an AFC system frontend of an AFC system.

For example, according to some aspects, as an AP provides its location to the unified request handler, the unified request handler can direct the inquiry to a correct AFC service (e.g., for a particular country) based on the unified request handler verifying that the AP is certified for that region and determining the country of operation for the AP. In some cases, in order to not run the country determination logic for each inquiry, a cache table (or database or other storage) can be built in the AFC system.

Two illustrative approaches are described herein, including a dedicated country determination application programming interface (API) and an integrated single URL solution.

The country determination API may be an API that can be offered as part of an existing AFC framework (e.g., the AFC unit 500 of FIG. 5 or other AFC framework). In some aspects, an AP (e.g., an SP AP) can transmit location information to a unified request handler. In some cases, the location information can include latitude and longitude (lat/long) information for the AP. The location information may be obtained, for example, using a Global Navigation Satellite System (GNSS) system. In some cases, the location may have some uncertaintyto account for potential uncertainty in the location, the API can support sending location objects (e.g., an indication of an area in which the AP is located), such as an as ellipse, linear polygon, radial polygon, etc. The location objects can be similar to or the same objects used in the Wi-Fi Alliance (WFA) System to Device Interface specification and have the same format as the AFC inquiry's location object (e.g., in a JavaScript Object Notation (JSON) format).

An illustrative example of an inquiry to the country determination API is provided below. In this example, a lat/long information may be provided along with an ellipse location object with radius information defined by a majorAxis and minorAxis indicating potential uncertainty in the lat/long information may be provided as shown below:

```
{
  “ellipse”: {
    “center”: {
      “longitude”: −122.39694,
      “latitude”: 37.78978
    },
    “majorAxis”: 10,
    “minorAxis”: 10,
    “orientation”: 0
  }
}
```

Another illustrative example of a sample inquiry to the country determination API including lat/long information along with a radial polygon indicating potential uncertainty in the lat/long information is provided below:

```
{
  “radialPolygon”: {
    “center”: {
      “latitude”: 43.64254,
      “longitude”: −79.38711
    },
    “outerBoundary”: [
      {
        “length”: 10,
        “angle”: 0
      },
      {
        “length”: 10,
        “angle”: 90
      },
      {
        “length”: 10,
        “angle”: 180
      },
      {
        “length”: 10,
        “angle”: 270
      }
    ]
  }
}
```

Another illustrative example of a sample inquiry to the country determination API including lat/long information along with a linear polygon including four points indicating potential uncertainty in the lat/long information is provided below:

```
{
  “linearPolygon”: {
    “outerBoundary”: [
      {
        “latitude”: 30.57094,
        “longitude”: −102.23787
      },
      {
        “latitude”: 30.57094,
        “longitude”: −102.23187
      },
      {
        “latitude”: 30.57694,
        “longitude”: −102.23187
      },
      {
        “latitude”: 30.57694,
        “longitude”: −102.23787
      }
    ]
  }
}
```

Another illustrative example of a sample inquiry to the country determination API including lat/long information of a point is provided below:

```
{
  “point”: {
    “latitude”: 49.28335,
    “longitude”: −123.10428
  }
}
```

Another illustrative example of a sample inquiry to the country determination API including lat/long information is provided below:

```
{
  “latitude”: 40.74848,
  “longitude”: −73.98566
}
```

In response to receiving the location information from the AP, the unified request handler can return information to the AP, such as the country code of the country in which the unified request handler determines the AP is located (based on the location information), valid rule set identifiers (IDs) (e.g., RulesetIDs) for AFC operation in the identified country (e.g., US 47_CFR PART_15_SUBPART_E, CA_RES_DBS-06), an AFC URL for that specific country (e.g., for which the AP can use to connect to the AFC service of the identified country), any combination thereof, and/or other country specific information. The AP can use the provided URL to transmit an AFC request the appropriate country/region AFC server based on the correct RulesetID in order to obtain a spectrum access grant (e.g., to communicate on the 6 GHz band). The RulesetID may identify a set of rules (e.g., regulatory rules for AFC operations in the identified country.

In some aspects, the unified request handler can determine the country in which the AP is located by comparing the provided location information (e.g., lat/long information, location object, etc.) against pre-stored country border data files (e.g., shapely files).

Illustrative examples of sample responses from the country determination API (in replay to an inquiry to the country determination API) are provided below:

### Response Example 1:

```
{
  “country”: “United States”,
  “country_code”: “US”,
  “rulesetId”: “US_47_CFR_PART_15_SUBPART_E”,
  “url”: “https://afcapi.qcs.qualcomm.com/availableSpectrumInquiry”
}
```

### Response Example 2:

```
{
  “country”: “Canada”,
  “country_code”: “CA”,
  “rulesetId”: “CA_RES_DBS-06”,
  “url”: “https://afcapi.canada.qcs.qualcomm.com/availableSpectrumInquiry”
}
```

Response Example 3: not one of the recognized countries (will eventually cover all countries)

```
{
  “country”: “Unknown”,
  “country_code”: “N/A”,
  “rulesetId”: “N/A”,
  “url”: “N/A”
}
```

In some examples, the AP can store the response from the API. The AP may use the information in the response from the API to contact the appropriate AFC for the AP's location. In some cases, the AP may access the API and repeat the inquiry each time the AP reboots (e.g., each time the AP is powered on). In such examples, the AP may only send a country location request to the API when it is rebooted.

In some cases, the API can also be used for purposes other than AFC. For example, the API can be used by the APs to determine country code and country specific regulation, such as power levels, bands of operation, and dynamic frequency coordination (DFS) rules.

As noted previously, the systems and techniques described herein also provide an integrated single URL solution. For example, a single URL can be provided to AP customers (e.g., manufacturers of SP APs). The AP (e.g., SP AP) device can send an AFC inquiry to the URL along with rulesetIDs supported by the APs (e.g., countries in which the AP is certified for SP operation). The AFC inquiries are directed to the correct (e.g., country-specific) AFC system by the AFC unified request handler service. The country determination can be a computationally complex task. In some cases, to reduce processing time (e.g., for each inquiry), a look up table mapping serial numbers (or other unique identifier of the AP) of APs to countries in which the APs are located (e.g., were last determined to be located) can be maintained.

FIG. 6 is a diagram illustrating an example of a system configured to implement the single URL solution 600, in accordance with aspects of the present disclosure. In some cases, an AP 602 may be certified to operate in multiple countries (e.g., regions). This certification may be process may be performed, for example, by an AP manufacturer and the AP manufacturer may provision the AP with certification information indicating the countries that the AP is certified for. This provisioning may be performed as a part of manufacturing the AP. In some cases, the certification information may include a certification ID and the certification ID may be a per-AP type (e.g., SKU) identifier. The AP may also be provisioned with a URL 604 of a unified request handler 606 and a unique serial ID (e.g., serial number).

As shown in FIG. 6, an single country AP 632 that is only certified for SP operation in a single country (e.g., the United States) may have a URL for the AFC system of that country (e.g., the US AFC 616) hard coded. In other cases, the single country AP may access an API (e.g., as discussed above) and obtain the URL for the AFC system of that country. The single country AP 632 may then directly access the AFC system of that country without a country determination. In some cases, a single country AP 632 may be provisioned with the URL 604 of the unified request handler 606 and the single country AP 632 may access the unified request handler 606 in a manner substantially similar to a multi-country AP 602.

In some cases, after an AP has been rebooted (e.g., booted), the AP may send an AFC inquiry to a unified request handler 606 using the URL 604. In some cases, the AFC inquiry may include certification information (e.g., certification ID 608 entries for the countries the AP 602 is certified for SP operation in). In some cases, the certification ID 608 may be stored in an array of certification IDs. In some cases, the certification ID may also include the unique serial number 610 of the AP. In some cases, each certification ID may indicate a particular country/region for which the AP is certified for SP operation).

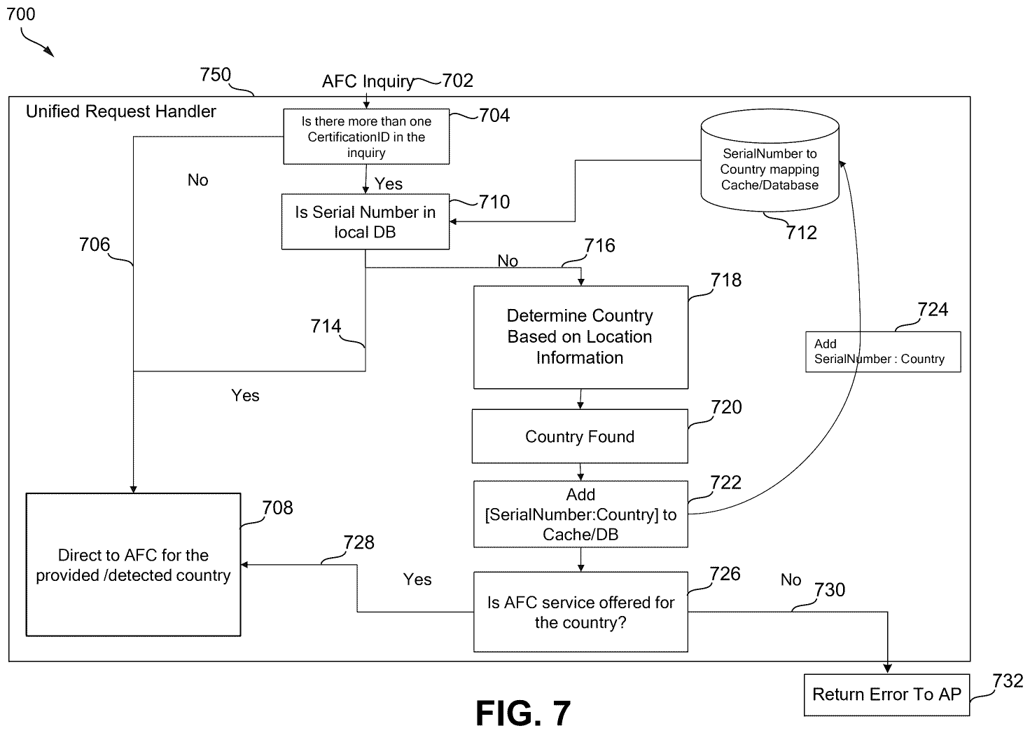

The unified request handler 606 can process AFC queries sent to the URL 604 from AP 602 that are certified for SP operation in multiple country. For instance, as shown in FIG. 6, the unified request handler 606 can include the country determination engine 612. The country determination engine 612 may determine the country (e.g., using the process shown in FIG. 7) in which the AP 602 is located based on location information provided by the AP 602 in the AFC inquiry. The location information can include lat/long information and/or a location object, as described above. Once a country in which the AP is located is determined, the local AFC routing engine 614 may retrieve a URL of a country specific (e.g., region specific) AFC system based on the determined location of the AP. The unified request handler 606 can then route the AFC inquiry to the applicable AFC system corresponding to the country in which the AP 602 is determined to be located. As an example, if the local AFC routing engine 614 determines that the AP 602 is located in the US, the AFC inquiry may be redirected to the US AFC 616. Similarly, if the local AFC routing engine 614 determines that the AP 602 is located in Canada, the AFC inquiry may be redirected to the Canada AFC 618, and so forth for other countries and other AFCs 620.

In some cases, multiple certification IDs may be sent to the unified request handler 606 by the AP 602. In some aspects, the AP 602 can use one serial number (unique per device) and a number of certification IDs, one for each country for which the AP 602 is certified.

In some cases, the unified request handler 606 may support staging, for example, for internal testing, research, development, etc. In some cases, staging versus production can be addressed using vendor extensions or API headers. For example, a testing/research/development/staging certification ID 608 may be supported. An AP 602 under development may use the single URL 604 with the testing/research/development/staging certification ID 608 and the local AFC routing engine 614 of the unified request handler 606 can forward the inquiry to one or more relevant AFC tasks (e.g., testing/staging/research/development/etc. AFC instead of production).

FIG. 7 is a block diagram illustrating an example process for determining a country in which an AP is located 700, in accordance with aspects of the present disclosure. For example, in response to receiving an AFC inquiry 702 from an AP (e.g., an AP, such as AP 400 of FIG. 4, AP 602 of FIG. 6, etc.), a unified request handler 750 (e.g., the unified request handler 606 of FIG. 6) can determine if there is more than one country 704 indicated in the AFC inquiry 702 for which the AP is certified to perform SP operations (e.g., if there is more than one certification ID in the inquiry). If there is only one country 706 indicated in the AFC inquiry 702, the unified request handler 750 can direct the AFC inquiry to the AFC for the provided/detected country 708.

If the AP is certified for multiple countries, the AP may include multiple certificationIDs in the AFC inquiry 702 along with a serial number associated with the AP, and location information for the AP, as discussed above. The unified request handler 750 may receive the serial number and certification IDs and the unified request handler 750 can determine 710 whether the serial number of the AP (which can be included in the AFC inquiry) is in a serial number to country mapping storage 712. In some cases, the serial number to country mapping storage 712 may be cache, database, or other storage. In some cases, the serial number may uniquely identify the AP. While examples are described herein using a serial number as an example identifier of an AP for illustrative purposes, other unique identifiers can also be used for APs and included in the storage for mapping purposes. In some cases, the serial number to country mapping storage 712 can be a local database of the unified request handler. For example, as determining the country 718 can be a relatively resource intensive operation, it may be useful to store (e.g., cache) a determined country for an AP for a period of time (e.g., an AP being set up/upgraded may reboot multiple times). In some aspects, the unified request handler 750 can perform a clean up operation for the serial number to country mapping storage 712. For instance, the serial number to country pairs of the serial number to country mapping storage 712 may be reset at a certain periodicity (e.g., every 30 days, every 60 days, etc.) to account for devices that might move between countries. If the unified request handler 750 determines 710 that the serial number of the AP is in 714 the serial number to country mapping storage 712, the unified request handler 750 may retrieve the serial number to country mapping and direct the AFC inquiry 702 to the AFC for the provided/detected country 708 (e.g., country AFC) based on the serial number to country mapping.

If the serial number of the AP (which can be included in the AFC inquiry) is not included 716 in the serial number to country mapping storage 712, the unified request handler 750 can determine the country 718 (e.g., using the process discussed above) in which the AP is located using the location information provided by the AP in the AFC inquiry 702 and/or using border maps (e.g., provided by the unified request handler). In some cases, the country search can be limited to countries for which the AP indicated it is certified for SP operation through the AFC inquiry 702. As noted previously, the location information included in the AFC inquiry from the AP can include lat/long information and/or a location object, as described above.

Once the country in which the AP is located is determined (e.g., the country is found 720), the unified request handler 750 can add 722 the serial number to country mapping 724 (e.g., [SerialNumber: Country]) to the serial number to country mapping storage 712.

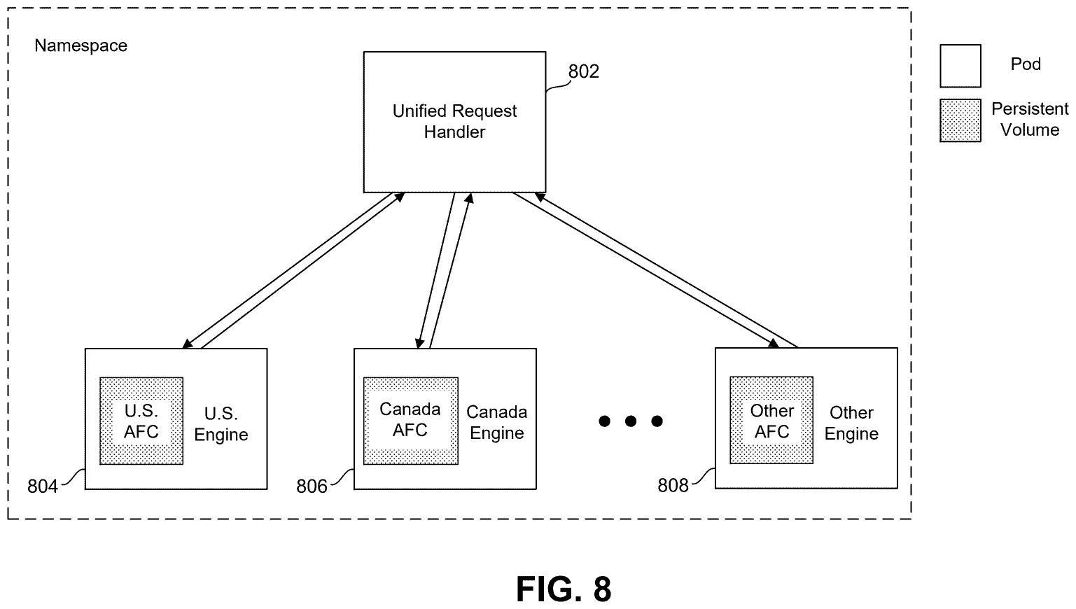

The unified request handler 750 can then determine whether AFC service is offered in the determined country 726. If AFC service is offered in the country 728, the unified request handler 750 can direct 708 the AFC inquiry 702 to a country AFC (e.g., an AFC engine, such as that shown in FIG. 8) for the provided/detected country. For instance, the unified request handler 750 can route the AFC inquiry 702 to the applicable country AFC system corresponding to the country in which the AP is determined to be located. If AFC service is not offered 730 in the determined country, the unified request handler 750 can return an error message 732 to the AP.

In some cases, the country AFC may perform a country check based on the location information from the AP in the AFC inquiry 702 separate from the unified request handler 750. This check may be performed by the country AFC when the serial number of the AP is in 714 the serial number to country mapping storage 712 and the country 718 determination is not performed. In some cases, the separate country check performed by the country AFC may be redundant when the unified request handler 750 has performed the country 718 determination. In some cases, the unified request handler 650 may route the AFC inquiry 702 to the applicable country AFC system along with an indication that country 718 determination was performed by the unified request handler 750. Based on this indication that country 718 determination was performed by the unified request handler 750, the country AFC may skip performing the separate country check.

FIG. 8 is a diagram illustrating an example architecture (e.g., a Kubernetes Architecture) for a unified request handler and various AFC engines 800, in accordance with aspects of the present disclosure. As shown, a unified request handler 802 is a pod (e.g., engine, container, etc.) in communication with various AFC pods (e.g., engines, container, etc.), including a U.S. AFC pod 804, a Canada AFC pod 806, and one or more “other” AFC pods 808 associated with another country/region. The various AFC pods (e.g., country AFCs) can include AFC operations, such as those described above with respect to FIGS. 2-5, US AFC 616, Canada AFC 618, and other AFC 620 of FIG. 6. The unified request handler 802 may perform operations such as those described above with respect to unified request handler 606 of FIG. 6, and unified request handler 750 of FIG. 7. For example, the unified request handler 802 may host a single end point (e.g., front end), such as a unified request handler that may be accessed by an AP, as discussed above with respect to FIGS. 6-8. The AP may send a query to the unified request handler 802 and the unified request handler 802 may direct the AP to an AFC pod (e.g., U.S. AFC pod 804, Canada AFC pod 806, another AFC pods 808) corresponding to the region and/or country as described above with respect to FIGS. 6-8. In some cases, the unified request handler 802 pod may also host the API, as discussed above.

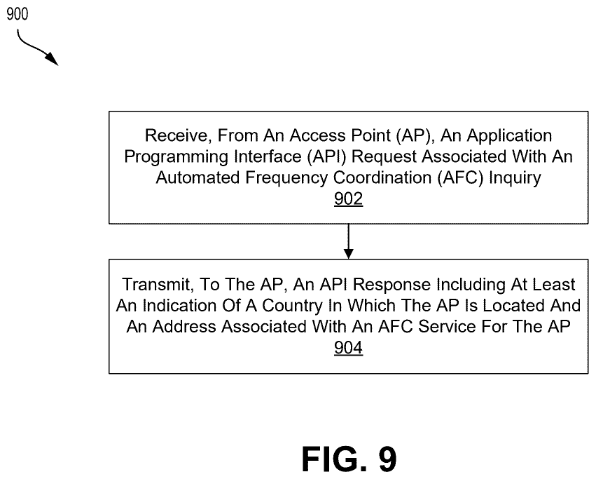

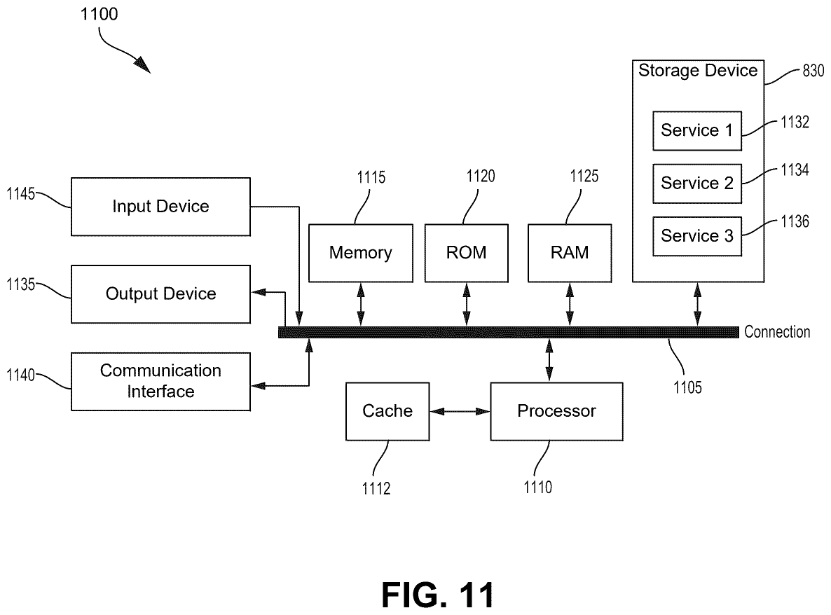

FIG. 9 is a flow diagram illustrating a process 900 for automated frequency coordination, in accordance with aspects of the present disclosure. The process 900 can be performed by a wireless node of a wireless network (e.g., AP 105, STA 115 of FIG. 1, AFC entity 220 of FIG. 2, AFC unit 500 of FIG. 5, unified request handler 606 of FIG. 6, unified request handler 700 of FIG. 7, unified request handler 802 of FIG. 8, computing system 1100 of FIG. 11, etc.). The wireless device may be an AP or a mobile device (e.g., a mobile phone) acting as an AP, such as a network-connected wearable such as a watch, an extended reality (XR) device such as a virtual reality (VR) device or augmented reality (AR) device, a vehicle or component or system of a vehicle, or other type of computing device. The operations of the process 900 may be implemented as software components that are executed and run on one or more processors (e.g., processor 1110 of FIG. 11 or other processor(s)).

At block 902, the computing device (or component thereof) may receive, from an access point (AP), an application programming interface (API) request associated with an automated frequency coordination (AFC) inquiry (e.g., AFC inquiry 702 of FIG. 7). In some cases, the API request includes location information indicating a location of the AP. In some examples, the location information includes at least one of a latitude and longitude of the AP or a location object associated with the AP. In some cases, the location object includes an ellipse, linear polygon, or a radial polygon indicating a location of the AP. In some examples, the computing device (or component thereof) may determine the country in which the AP is located using the location information in the API request. In some cases, the computing device (or component thereof) may to determine the country in which the AP is located by comparing the location information in the API request with pre-stored country border data files. In some examples, the API request further includes an indication of one or more countries for which the AP is certified for Standard Power (SP) operation. In some cases, the AP is a Standard Power AP.

At block 904, the computing device (or component thereof) may transmit, to the AP, an API response including at least an indication of a country in which the AP is located and an address associated with an AFC service for the AP. For example, a unified request handler can direct AP to the AFC for the provided/detected country. In some examples, the API response further includes rule set identifiers (IDs). In some cases, the computing device (or component thereof) may verify, based on the indication, that the AP is certified for SP operation in the country in which the AP is located.

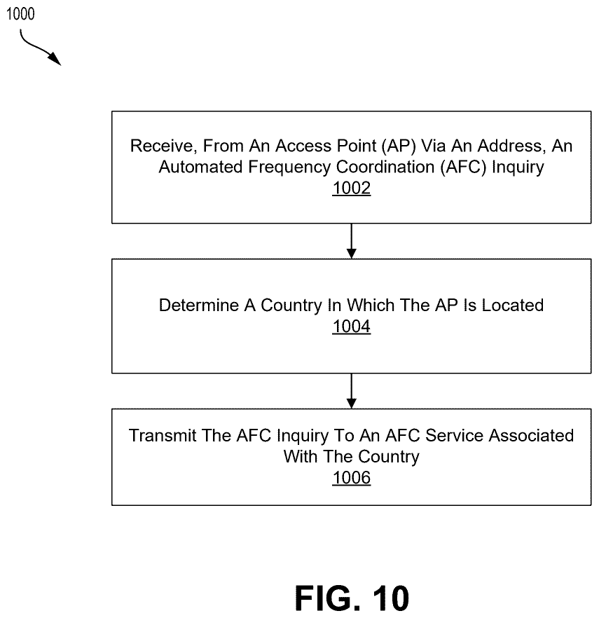

FIG. 10 is a flow diagram illustrating a process 1000 for user authentication, in accordance with aspects of the present disclosure. The process 1000 can be performed by a wireless node of a wireless network (e.g., AP 105, STA 115 of FIG. 1, AFC entity 220 of FIG. 2, AFC unit 500 of FIG. 5, unified request handler 606 of FIG. 6, unified request handler 700 of FIG. 7, unified request handler 802 of FIG. 8, computing system 1100 of FIG. 11, etc.). The wireless device may be an AP or a mobile device (e.g., a mobile phone) acting as an AP, such as a network-connected wearable such as a watch, an extended reality (XR) device such as a virtual reality (VR) device or augmented reality (AR) device, a vehicle or component or system of a vehicle, or other type of computing device. The operations of the process 1000 may be implemented as software components that are executed and run on one or more processors (e.g., processor 1110 of FIG. 11 or other processor(s)).

At block 1002, the computing device (or component thereof) may receive, from an access point (AP) (e.g., SP AP 602 of FIG. 6, SP AP 632 of FIG. 6) via an address, an automated frequency coordination (AFC) inquiry. In some cases, the address is a uniform resource locator (URL). In some examples, the AFC inquiry includes an identifier of the AP (e.g., unique serial number 610 of FIG. 6 of the AP).

At block 1004, the computing device (or component thereof) may determine a country in which the AP is located (e.g., determining the country 718 of FIG. 7). In some cases, the computing device (or component thereof) may determine a number of countries for which the AP is certified for Standard Power (SP) operation (e.g., determining if there is more than one country 704 of FIG. 7). In some examples, the computing device (or component thereof) may, based on a determination that the number of countries for which the AP is certified for SP operation is greater than one, compare identifier to an identifier-to-country mapping in the at least one memory. In some cases, the identifier of the AP is a serial number of the AP.

At block 1006, the computing device (or component thereof) may transmit the AFC inquiry to an AFC service associated with the country.

The processes described herein may be performed by a computing device or apparatus utilizing or implementing any of the systems or techniques described herein. The computing device can include any suitable device, such as a server computer, a mobile device (e.g., a mobile phone), a desktop computing device, a tablet computing device, an XR device (e.g., a VR headset, an AR headset, AR glasses, etc.), a wearable device (e.g., a network-connected watch or smartwatch, or other wearable device), a vehicle (e.g., an autonomous vehicle) or computing device of the vehicle, a robotic device, a laptop computer, a smart television, a camera, and/or any other computing device with the resource capabilities to perform the processes described herein. In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, a network interface configured to communicate and/or receive the data, any combination thereof, and/or other component(s). The network interface may be configured to communicate and/or receive Internet Protocol (IP) based data or other type of data.

The components of the computing device can be implemented in circuitry. For example, the components can include and/or can be implemented using electronic circuits or other electronic hardware, which can include one or more programmable electronic circuits (e.g., microprocessors, graphics processing units (GPUs), digital signal processors (DSPs), central processing units (CPUs), and/or other suitable electronic circuits), and/or can include and/or be implemented using computer software, firmware, or any combination thereof, to perform the various operations described herein.

The processes (e.g., the process of FIG. 7) may be illustrated as a logical flow diagram, the operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

Additionally, the processes described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 11 is a diagram illustrating an example of a system for implementing certain aspects of the present disclosure. In particular, FIG. 11 illustrates an example of computing system 1100, which can be for example any computing device making up a computing system, a camera system, or any component thereof in which the components of the system are in communication with each other using connection 1105. Connection 1105 can be a physical connection using a bus, or a direct connection into processor 1110, such as in a chipset architecture. Connection 1105 can also be a virtual connection, networked connection, or logical connection.

In some examples, computing system 1100 is a distributed system in which the functions described in this disclosure can be distributed within a datacenter, multiple data centers, a peer network, etc. In some examples, one or more of the described system components represents many such components each performing some or all of the function for which the component is described. In some examples, the components can be physical or virtual devices.

Example system 1100 includes at least one processing unit (CPU or processor) 1110 and connection 1105 that couples various system components including system memory, such as memory 1115, read-only memory (ROM) 1120, and/or random access memory (RAM) 1125 to processor 1110. Computing system 1100 can include a cache 1112 of high-speed memory connected directly with, in close proximity to, or integrated as part of processor 1110.

Processor 1110 can include any general purpose processor and a hardware service or software service, such as services 1132, 1134, and 1136 stored in storage device 1130, configured to control processor 1110 as well as a special-purpose processor where software instructions are incorporated into the actual processor design. Processor 1110 may essentially be a completely self-contained computing system, containing multiple cores or processors, a bus, memory controller, cache, etc. A multi-core processor may be symmetric or asymmetric.

To enable user interaction, computing system 1100 includes an input device 1145, which can represent any number of input mechanisms, such as a microphone for speech, a touch-sensitive screen for gesture or graphical input, keyboard, mouse, motion input, speech, etc. Computing system 1100 can also include output device 1135, which can be one or more of a number of output mechanisms. In some instances, multimodal systems can enable a user to provide multiple types of input/output to communicate with computing system 1100. Computing system 1100 can include communications interface 1140, which can generally govern and manage the user input and system output.

The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

The communications interface 1140 may also include one or more Global Navigation Satellite System (GNSS) receivers or transceivers that are used to determine a location of the computing system 1100 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1130 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1130 can include software services, servers, services, etc., that when the code that defines such software is executed by the processor 1110, it causes the system to perform a function. In some examples, a hardware service that performs a particular function can include the software component stored in a computer-readable medium in connection with the necessary hardware components, such as processor 1110, connection 1105, output device 1135, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Specific details are provided in the description above to provide a thorough understanding of the aspects and examples provided herein. However, it will be understood by one of ordinary skill in the art that the aspects and examples may be practiced without these specific details. For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects and examples in unnecessary detail. In other instances, well-known circuits, processes, algorithms, structures, and techniques may be shown without unnecessary detail in order to avoid obscuring the aspects and examples.

Individual aspects and examples may be described above as a process or method which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

Processes and methods according to the above-described examples can be implemented using computer-executable instructions that are stored or otherwise available from computer-readable media. Such instructions can include, for example, instructions and data which cause or otherwise configure a general purpose computer, special purpose computer, or a processing device to perform a certain function or group of functions. Portions of computer resources used can be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

Devices implementing processes and methods according to these disclosures can include hardware, software, firmware, middleware, microcode, hardware description languages, or any combination thereof, and can take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Typical examples of form factors include laptops, smart phones, mobile phones, tablet devices or other small form factor personal computers, personal digital assistants, rackmount devices, standalone devices, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are example means for providing the functions described in the disclosure.

In the foregoing description, aspects of the application are described with reference to specific examples thereof, but those skilled in the art will recognize that the application is not limited thereto. Thus, while illustrative aspects and examples of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects and examples can be utilized in any number of environments and applications beyond those described herein without departing from the broader spirit and scope of the specification. The specification and drawings are, accordingly, to be regarded as illustrative rather than restrictive. For the purposes of illustration, methods were described in a particular order. It should be appreciated that in alternate aspects and examples, the methods may be performed in a different order than that described.

One of ordinary skill will appreciate that the less than (“<”) and greater than (“>”) symbols or terminology used herein can be replaced with less than or equal to (“≤”) and greater than or equal to (“≥”) symbols, respectively, without departing from the scope of this description.

Where components are described as being “configured to” perform certain operations, such configuration can be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of”′ a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

The various illustrative logical blocks, modules, circuits, and algorithm steps described in connection with the examples disclosed herein may be implemented as electronic hardware, computer software, firmware, or combinations thereof. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present application.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, then the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that can be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

### Illustrative Aspects of the Present Disclosure Include:

Aspect 1. An apparatus comprising: at least one memory; and at least one processor coupled to the at least one memory, the at least one processor configured to: receive, from an access point (AP), an application programming interface (API) request associated with an automated frequency coordination (AFC) inquiry, wherein the API request includes location information indicating a location of the AP; and transmit, to the AP, an API response including at least an indication of a country in which the AP is located and an address associated with an AFC service for the AP.

Aspect 2. The apparatus of Aspect 1, wherein the AP is a Standard Power AP.

Aspect 3. The apparatus of any one of Aspects 1 or 2, wherein the location information includes at least one of a latitude and longitude of the AP or a location object associated with the AP.

Aspect 4. The apparatus of Aspect 3, wherein the location object includes an ellipse, linear polygon, or a radial polygon indicating a location of the AP.

Aspect 5. The apparatus of any one of Aspects 1 to 4, wherein the API response further includes rule set identifiers (IDs).

Aspect 6. The apparatus of any one of Aspects 1 to 5, wherein the at least one processor is configured to: determine the country in which the AP is located using the location information in the API request.

Aspect 7. The apparatus of Aspect 6, wherein, to determine the country in which the AP is located, the at least one processor is configured to: compare the location information in the API request with pre-stored country border data files.

Aspect 8. The apparatus of any one of Aspects 1 to 7, wherein the API request further includes an indication of one or more countries for which the AP is certified for Standard Power (SP) operation.

Aspect 9. The apparatus of Aspect 8, wherein the at least one processor is configured to: verify, based on the indication, that the AP is certified for SP operation in the country in which the AP is located.

Aspect 10. A method comprising: receiving, from an access point (AP), an application programming interface (API) request associated with an automated frequency coordination (AFC) inquiry, wherein the API request includes location information indicating a location of the AP; and transmitting, to the AP, an API response including at least an indication of a country in which the AP is located and an address associated with an AFC service for the AP.

Aspect 11. The method of Aspect 10, wherein the AP is a Standard Power AP.

Aspect 12. The method of any one of Aspects 10 or 11, wherein the location information includes at least one of a latitude and longitude of the AP or a location object associated with the AP.

Aspect 13. The method of Aspect 12, wherein the location object includes an ellipse, linear polygon, or a radial polygon indicating a location of the AP.

Aspect 14. The method of any one of Aspects 10 to 13, wherein the API response further includes rule set identifiers (IDs).

Aspect 15. The method of any one of Aspects 10 to 14, further comprising: determining the country in which the AP is located using the location information in the API request.

Aspect 16. The method of Aspect 15, wherein determining the country in which the AP is located comprises: comparing the location information in the API request with pre-stored country border data files.

Aspect 17. The method of any one of Aspects 10 to 16, wherein the API request further includes an indication of one or more countries for which the AP is certified for Standard Power (SP) operation.

Aspect 18. The method of Aspect 17, further comprising: verifying, based on the indication, that the AP is certified for SP operation in the country in which the AP is located.

Aspect 19. An apparatus comprising: at least one memory; and at least one processor coupled to the at least one memory, the at least one processor configured to: receive, from an access point (AP) via an address, an automated frequency coordination (AFC) inquiry; determine a country in which the AP is located; and transmit the AFC inquiry to an AFC service associated with the country.

Aspect 20. The apparatus of Aspect 19, wherein the address is a uniform resource locator (URL).

Aspect 21. The apparatus of any one of Aspects 19 or 20, wherein the at least one processor is configured to: determine a number of countries for which the AP is certified for Standard Power (SP) operation.

Aspect 22. The apparatus of Aspect 21, wherein the AFC inquiry includes an identifier of the AP, and wherein the at least one processor is configured to: based on a determination that the number of countries for which the AP is certified for SP operation is greater than one, compare identifier to an identifier-to-country mapping in the at least one memory.

Aspect 23. The apparatus of Aspect 22, wherein the identifier of the AP is a serial number of the AP.

Aspect 24. A method comprising: receiving, from an access point (AP) via an address, an automated frequency coordination (AFC) inquiry; determining a country in which the AP is located; and transmitting the AFC inquiry to an AFC service associated with the country.

Aspect 25. The method of Aspect 24, wherein the address is a uniform resource locator (URL).

Aspect 26. The method of any one of Aspects 24 or 25, further comprising: determining a number of countries for which the AP is certified for Standard Power (SP) operation.

Aspect 27. The method of Aspect 26, wherein the AFC inquiry includes an identifier of the AP, and further comprising: based on a determination that the number of countries for which the AP is certified for SP operation is greater than one, comparing the identifier to an identifier-to-country mapping in at least one memory.

Aspect 28. The method of Aspect 27, wherein the identifier of the AP is a serial number of the AP.

Aspect 29. A non-transitory computer-readable storage medium comprising instructions stored thereon which, when executed by at least one processor, causes the at least one processor to perform operations according to any one of Aspects 10 to 18.

Aspect 30. An apparatus comprising one or more means for performing operations according to any one of Aspects 10 to 18.

Aspect 31. A non-transitory computer-readable storage medium comprising instructions stored thereon which, when executed by at least one processor, causes the at least one processor to perform operations according to any one of Aspects 24 to 28.

Aspect 32. An apparatus comprising one or more means for performing operations according to any one of Aspects 24 to 28.

What is claimed is:

1. An apparatus comprising:
at least one memory; and
at least one processor coupled to the at least one memory, the at least one processor configured to:
receive, from an access point (AP), an application programming interface (API) request associated with an automated frequency coordination (AFC) inquiry, wherein the API request includes location information indicating a location of the AP; and
transmit, to the AP, an API response including at least an indication of a country in which the AP is located and an address associated with an AFC service for the AP.

2. The apparatus of claim 1, wherein the AP is a Standard Power AP.

3. The apparatus of claim 1, wherein the location information includes at least one of a latitude and longitude of the AP or a location object associated with the AP.

4. The apparatus of claim 3, wherein the location object includes an ellipse, linear polygon, or a radial polygon indicating a location of the AP.

5. The apparatus of claim 1, wherein the API response further includes rule set identifiers (IDs).

6. The apparatus of claim 1, wherein the at least one processor is configured to:
determine the country in which the AP is located using the location information in the API request.

7. The apparatus of claim 6, wherein, to determine the country in which the AP is located, the at least one processor is configured to:
compare the location information in the API request with pre-stored country border data files.

8. The apparatus of claim 1, wherein the API request further includes an indication of one or more countries for which the AP is certified for Standard Power (SP) operation.

9. The apparatus of claim 8, wherein the at least one processor is configured to:
verify, based on the indication, that the AP is certified for SP operation in the country in which the AP is located.

10. A method comprising:
receiving, from an access point (AP), an application programming interface (API) request associated with an automated frequency coordination (AFC) inquiry, wherein the API request includes location information indicating a location of the AP; and
transmitting, to the AP, an API response including at least an indication of a country in which the AP is located and an address associated with an AFC service for the AP.

11. The method of claim 10, wherein the AP is a Standard Power AP.

12. The method of claim 10, wherein the location information includes at least one of a latitude and longitude of the AP or a location object associated with the AP.

13. The method of claim 12, wherein the location object includes an ellipse, linear polygon, or a radial polygon indicating a location of the AP.

14. The method of claim 10, wherein the API response further includes rule set identifiers (IDs).

15. The method of claim 10, further comprising:
determining the country in which the AP is located using the location information in the API request.

16. An apparatus comprising:
at least one memory; and
at least one processor coupled to the at least one memory, the at least one processor configured to:
receive, from an access point (AP) via an address, an automated frequency coordination (AFC) inquiry;
determine a country in which the AP is located; and
transmit the AFC inquiry to an AFC service associated with the country.

17. The apparatus of claim 16, wherein the address is a uniform resource locator (URL).

18. The apparatus of claim 16, wherein the at least one processor is configured to:
determine a number of countries for which the AP is certified for Standard Power (SP) operation.

19. The apparatus of claim 18, wherein the AFC inquiry includes an identifier of the AP, and wherein the at least one processor is configured to:
based on a determination that the number of countries for which the AP is certified for SP operation is greater than one, compare identifier to an identifier-to-country mapping in the at least one memory.

20. The apparatus of claim 19, wherein the identifier of the AP is a serial number of the AP.
